(19) United States
(12) Patent Application Publication
(10) Pub. No.: US 2010/0262847 A1
(43) Pub. Date: Oct. 14, 2010

(54) APPARATUS AND METHODS OF CONTROLLING A POWER MANAGEMENT MODE OF A DIGITAL PROCESING DEVICE

(75) Inventors: Woo Sik KIM, Hwasung-si (KR); Jin Wan Jun, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/758,192

(22) Filed: Apr. 12, 2010

(30) Foreign Application Priority Data
Apr. 14, 2009 (KR) 2009-0032382

(51) Int. Cl. G06F 1/32

(52) U.S. Cl. 713/310; 713/320

(57) ABSTRACT

An apparatus and method of controlling power consumption of a digital processing device. The apparatus and method determine whether a power management mode of the digital processing device is enabled. When a power management mode is enabled, the power is reduced to at least one portion of the digital processing device to fully power one or more memory devices of the digital processing device to a normal operation ready state. When the power management mode is disabled, power is provided to the one or more memory devices of the digital processing device to the normal operation ready state.

### CROSS-REFERENCE TO RELATED APPLICATIONS

This application claims the priority under 35 U.S.C. §119(a) of Korean Patent Application No. 10-2009-0032382, filed on Apr. 14, 2009, in the Korean Intellectual Property Office, the disclosure of which is incorporated herein by reference in its entirety.

### BACKGROUND OF THE INVENTION

1. Field of the Invention

The present general inventive concept relates to apparatus and methods of controlling a power management mode of a digital processing device, and in particular, relate to methods of managing a digital processing device to control power in the device and to one or more memory devices in the digital processing device according to whether the power management mode is enabled or disabled, and to a controller to control the power management modes of a digital processing device and to control the power to the one or more memory devices in the digital processing device.

2. Description of the Related Art

Digital storage devices, such as hard disk drives (HDDs), are typically formed of electronic parts and mechanical parts are one of memory devices for recording and reproducing data by converting digital electric pulses to a magnetic field. The HDD typically has a single disk to store the data. The single disk, which is coupled to a spindle motor, is spun up to a predetermined operating speed at the start of the normal hard disk drive operation.

However, it is possible for the disk to fail to spin up to the predetermined operating speed because of an insufficient power supply to the disk. For example, only a predetermined amount of power is typically provided to the HDD, and the power has to be used to not only power the spindle motor to spin up the disk to the predetermined operating speed, but also to provide power to the control circuitry and other electrical components of the HDD.

More recently, in order to increase the data storage capacity of the HDD, more disks have been added to the HDD, all of which must be spun to the predetermined operating speed by the spindle motor. Typically, it requires more power to spin up HDDs with multiple disks than a HDD with a single disk.

The power supplied to the HDD is typically controlled or is limited by a system condition. Thus, when the disks of the HDD are spun up to a predetermined operating speed to a start up operation speed, a spin up failure can occur if the HDD requires more power than is available to the HDD from the supplied power in order to power the spindle motor.

For example, a USB (Universal Serial Bus) interface allows a maximum current of 500 mA via the interface. When the disks of the HDD have already been spun up to a normal operation speed, the available current via the USB is usually sufficient to operate the HDD adequately. However, at the start of operations of the HDD, especially one with multiple disks, the spindle motor requires sufficient current in order rotate the one or more disks. It is possible that the current supplied via the USB interface to the spindle motor is not enough to spin up the one or more disks to achieve a normal operating speed, and the HDD can fail to achieve a ready status. If the HDD or other type of digital storage device fails to achieve a ready status, data cannot be retrieved from or written to the storage device.

### SUMMARY OF THE INVENTION

The present general inventive concept provides a controller to control the power consumption and power operation modes of a digital processing device that includes and/or is coupled to a digital storage device. The present general inventive concept also provides a method of controlling the power consumption and power operation modes of the digital processing device, as well as controlling the power supplied to the one or more memory devices in the digital processing device.

Additional and/or other features and utilities of the present general inventive concept will be set forth in part in the description which follows and, in part, will be obvious from the description, or may be learned by practice of the general inventive concept.

Exemplary embodiments of the present general inventive concept provide a method of controlling power consumption of a digital processing device, the method including determining whether a power management mode of the digital processing device is enabled, when a power management mode is enabled, reducing power to at least one portion of the digital processing device to fully power one or more memory devices of the digital processing device to a normal operation ready state, and when the power management mode is disabled, powering the one or more memory devices of the digital processing device to the normal operation ready state.

The method may also include when the one or more memory devices of the digital processing device are at the normal operation ready state, determining whether the power management mode of the digital processing device is enabled, and supplying power to a wired or wireless communications interface of the digital processing device.

The method may include where the reducing power to at least one portion of the digital processing device comprises reducing the power to a wired or wireless communications interface of the digital processing device.

The method may further include determining that a communications link has been established between the digital processing device and a host device before the determining whether the power management mode of the digital processing device is enabled.

The method may further include the determining whether a power management mode of the digital processing device is enabled includes receiving a request from a host via a wired or wireless communications link to enable or disable the power management mode, and setting the power management mode according to the received command by storing the set mode in a memory device of the digital processing device.

The method may further include erasing any previously-stored power management mode setting.

The method may further include transmitting a request to enable the power management mode from the digital processing device to a host device, transmitting an acknowledgement of the request from the host device to the digital processing device, and operating the host device and the digital processing device in the power management mode.

The method may include where the operating the host device in the power management mode includes withholding requests to read data from or write data to the digital processing device until the digital processing device is in the normal operation ready state.

The method may include where the digital processing device includes a hard disk drive and the normal operation ready state is a predetermined operation speed of the hard disk drive.

The method may include where the digital processing device includes one or more solid state memory devices and when the power management mode is enabled, transferring power applied to charge capacitors to power the one or more solid state memory devices to the normal operation ready state.

Exemplary embodiments of the present general inventive concept may provide a controller to control a digital processing device, the controller including a power management mode determination device to determine whether a power management mode of the digital processing device is enabled, and a power controller to reduce power to at least one portion of the digital processing device to fully power one or more memory devices of the digital processing device to a normal operation ready state, and to power the one or more memory devices of the digital processing device to the normal operation ready state when the power management mode is disabled.

The controller may further include a processor to determine whether the power management mode of the digital processing device is enabled when the one or more memory devices of the digital processing device are at the normal operation ready state, and the power controller to supply power to a wired or wireless communications interface of the digital processing device.

The controller may include where the power reduces the power to a wired or wireless communications interface of the digital processing device.

The controller may include where the power management mode determination device determines that a communications link has been established between the digital processing device and a host device before the determining whether the power management mode of the digital processing device is enabled.

The controller may further include a wired or wireless communications interface to receive a request from a host to enable or disable the power management mode, and a digital storage device to set and store the power management mode.

The controller may include where the digital storage device erases any previously-stored power management mode setting in the digital storage device.

The controller may further include a wired or wireless communications interface to transmit a request to enable the power management mode from the digital processing device to a host device, and to receive an acknowledgement of the request from the host device to the digital processing device, where the controller operates the host device and the digital processing device in the power management mode upon receipt of the acknowledgement.

The controller may withholds requests from the host to read data from or write data to the digital processing device until the digital processing device is in the normal operation ready state.

The controller may further comprise a hard disk drive communicatively coupled to the controller, where the normal operation ready state is a predetermined operation speed of the hard disk drive.

The controller may include where the power controller transfers power applied to charge capacitors of the digital processing device that includes one or more solid state memory devices to power the one or more solid state memory devices to the normal operation ready state when the power management mode is enabled.

### BRIEF DESCRIPTION OF THE DRAWINGS

The above and/or other aspects and advantages of the present general inventive concept will become apparent and more readily appreciated from the following detailed description, taken in conjunction with the accompanying drawings of which:

FIG. 1 illustrates a hard disk drive (HDD) apparatus of a digital processing device according exemplary embodiments of the present general inventive concept;

FIGS. 2A and 2B are block diagrams illustrating host systems communicatively coupled to digital processing devices that include a HDD (as illustrated in FIG. 2A) or digital storage device (as illustrated in FIG. 2B) according exemplary embodiments of the present general inventive concept;

FIG. 3 illustrates a timing diagram of an Initiate Power Management (IPM) function according exemplary embodiments of the present general inventive concept;

FIG. 4 illustrates a method of staggering spin-up of the HDD and staggering the reaching of a normal operating mode of the digital storage device according exemplary embodiments of the present general inventive concept;

FIG. 5 illustrates the operations of staggering the spin-up the HDD and bringing the digital storage device to a normal operation mode with power management according exemplary embodiments of the present general inventive concept; and

FIG. 6 illustrates a method of setting information of the power management mode to enable or disable the power management mode according exemplary embodiments of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

Exemplary embodiments of the present general inventive concept include a digital processing device with a controller to control power consumption of a processor and/or interface to operate a hard disk drive to spin up or to bring a digital storage device to a normal operating state. The digital processing device may include a non-volatile memory to store setting information to enable or disable a power management function. When the power management is enabled, the power consumed by the interface is controller so as to provide power to the hard disk drive and/or digital storage device.

Exemplary embodiments of the present general inventive concept may minimize or prevent a spin up failure of hard disk drive or failure of a digital storage device to achieve a normal operating state by controlling the power consumption of devices included in the digital processing device.

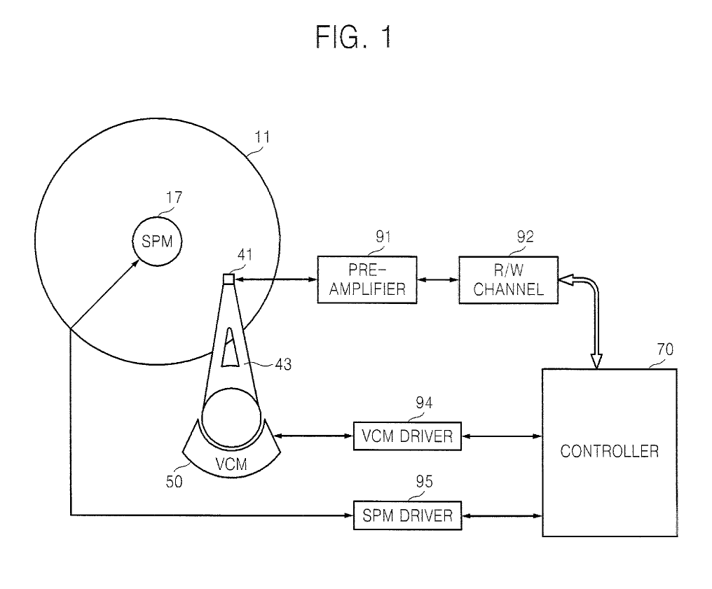

FIG. 1 is a block diagram illustrating hard disk drive (HDD) 10. The HDD 10 includes a one or more disks 11, a spindle motor 17 that rotates the disks 11, a magnetic head 41, an actuator arm 43, a voice coil motor (VCM) 50, a pre-amplifier (Pre-AMP) 91, a read/write (R/W) channel 92, a voice coil driver 94, a spindle motor (SPM) driver 95, and a controller 70.

The VCM 50 is a drive motor to pivot an actuator arm 43 to move the magnetic head 41 to a desired position on the disk 11 using the Fleming's left hand rule, that is, a force is generated when a current is applied to a conductive body existing in a magnetic field. As a current is applied to a VCM coil located between magnets in the voice coil motor 50, a force is applied to a bobbin (not illustrated) so that the bobbin is rotated. Accordingly, as the actuator arm 43 extending in a direction opposite to the bobbin from a pivot shaft holder (not illustrated) pivots so that the magnetic head 41 supported at a tip end of the actuator arm 43 is moved in a radial direction on the disk 11 that is rotated, searches for a track, accesses the searched track, and performs signal process of the accessed information.

The magnetic head (read/write head) 41 may write data to or read recorded data from the disk 11. When reading or writing data to the disk 11, the actuator arm 43 may pivot around a pivot shift to enable the magnetic head 41 to access the data on the disk 11. A suspension (not illustrated) may be coupled to the end portion of the actuator arm 43. The pivot shaft holder may rotatably support the pivot shaft 42, where the actuator arm 43 is coupled and supported. The bobbin may move in a direction opposite to the actuator arm 43 with respect to the pivot shaft holder, and may be located between the VCM 50 and the magnets.

The magnetic head 41 reads or records information with respect to the disk 11 that is rotated by detecting a magnetic field formed on the surface of the disk 11 or by magnetizing the surface of the disk 11. The magnetic head 41 includes a read head (not illustrated) to detect the magnetic field of the disk 11 and a write head (not illustrated) to magnetize the disk 11.

The Pre-AMP 91 can amplify a read signal generated by the read head that detects a magnetic field from the disk 11 and outputs the amplified read signal to the R/W channel 92, and/or can amplify a current of a particular waveform received from the R/W channel 92 and supply the amplified current to the write head.

The R/W channel 92 can convert the read signal amplified by the pre-amplifier 91 to a digital signal and output the converted read signal to the controller 70. Also, the R/W channel 92 can receive the data that is received by the host interface 93 via the controller 70, convert the received data to an analog signal, and can output the analog signal to the pre-amplifier 91.

The VCM driver 94 can control the amount of a current applied to the VCM 50 according to a control signal of the controller 70. The SPM driver 95 can control the amount of a current applied to a spindle motor 17 according to a control signal of the controller 70.

The controller 70 can receive via the host interface 93 data input by a user through the host device and can output the received data to the R/W channel 92 in a data recording mode, and can receive a read signal converted to a digital signal by the R/W channel 92 and can output the received signal to the host interface 93 in a data determination mode. Also, the controller 70 can control outputs of the VCM driver 94 and the spindle motor driver 95.

The controller 70 can be a microprocessor or a microcontroller and can be implemented in the form of software or firmware.

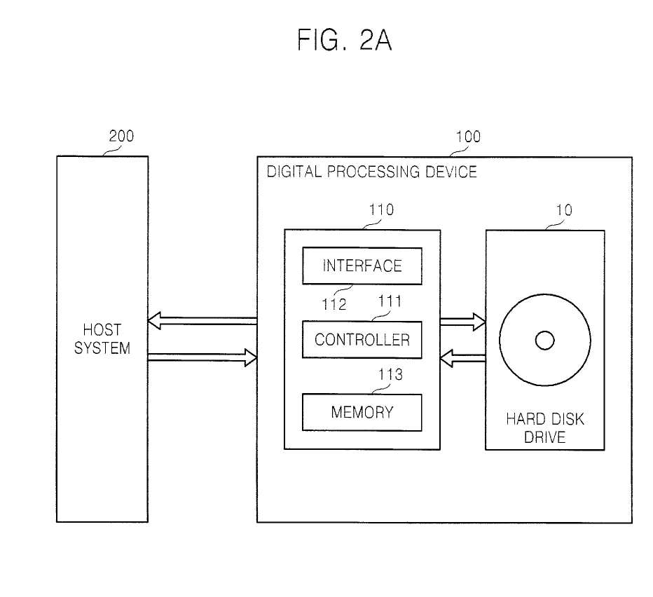

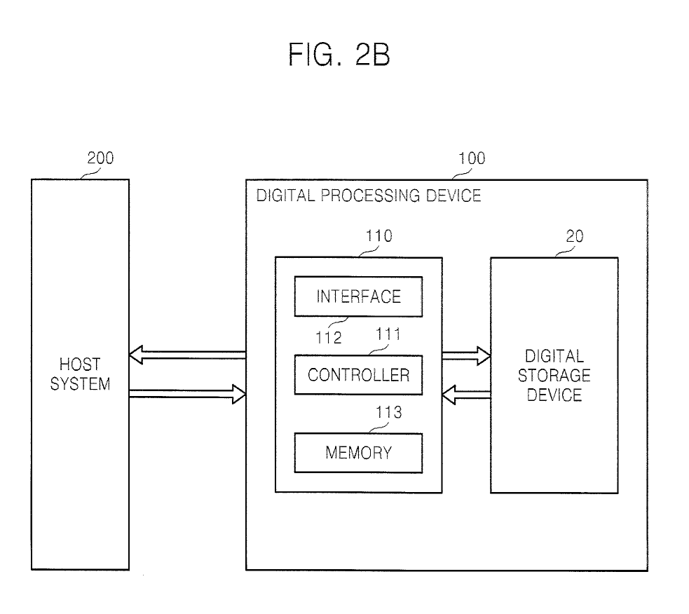

Turning to FIGS. 2A and 2B, FIG. 2A illustrates the HDD 10 of FIG. 1 included in a digital processing device 100, that is communicatively coupled to a host system 200 via wired or wireless communications link. The digital processing device 100 includes a processor 110 that has a controller 111, an interface 112, and a memory 113. The controller 111 may be a digital signal processor, a microprocessor, microcontroller, or the like. Memory 113 may be any suitable non-volatile memory, such as flash memory. FIG. 2B illustrates a digital storage device 20 communicatively coupled to the processor 110. The digital storage device 20 may include one or more solid-state non-volatile memory devices or the like.

Interface 112 may transmit and/or receive data via the wired and/or wireless communications link with the host system 200. Interface 112 may be, for example, a SATA interface (Serial AT Attachment) of a SATA interface block.

The controller 111 may direct power from a power source of the digital processing device 100 to the HDD 10 or the digital storage device 20. The controller 111 may also control the HDD 10 to spin up the one or more disks 11 to a predetermined operating speed, and/or control the HDD 10 or digital storage device 20 to a normal operation ready state.

The controller 111 may control the spin-up of the one or more disks 11 or bring the HDD 10 or digital storage device 20 to a normal operation ready state, the controller 111 may also spin down the disks 11 or reduce the operational state of the HDD 10 or digital storage device 20. For example, the controller 111 may control the spin-up or spin-down of the disks 11, or bring the digital storage device 20 to a normal or reduced operation ready state according to an event or request by the host system 200.

In exemplary embodiments of the present general inventive concept, the controller 111 may control the power consumption of the interface 111 before and/or during the spin-up of the disks 11 or in bringing the digital storage device 20 to a normal operation state. In a typical system, the power available to the HDD 10 or the digital storage device 20 is reduced, as the interface 112 utilizes at least a portion of the available power. In exemplary embodiments of the present general inventive concept, the controller 111 may control the available power to the HDD 10 or the digital storage device 20 to minimize and/or prevent spin-up failure errors of the disks 11 of the HDD 10 or the failure to bring the digital storage device 20 to a normal operations state due to insufficient power. For example, the controller 111 may control the power consumption of the interface 112 (e.g., before a spin-up operation of the disks 11 of the HDD 10).

In exemplary embodiments of the present general inventive concept, the spin-up of disks 11 of HDD 10 or bringing the digital storage device 20 to a normal operations state may be staggered over a predetermined amount of time. For example, in exemplary embodiments of the present general inventive concept, the staggered spin-up and/or achieving a normal operating state may be controlled by the controller when a physical and/or communications link is established between the host system 200 and the digital processing device 100. In exemplary embodiments, where a plurality of HDD 10s and/or digital storage device 20s are included with and/or coupled to digital processing device 100, the controller 111 may stagger the spin-up of the disks or stagger the bringing a digital storage device 20 to a normal operation state.

The interface 112 and/or the processor 110 of the digital processing device 100 may have a plurality of power status states. For example, in a “PHYRDY” state, the processor 110 may be on and active, and the interface 112 may be synchronized and capable of sending and receiving data (e.g., sending data to or receiving data from the host system 200). In a “Partial” state, the processor 110 may be powered, but in a reduced power state, and the input/output lines of the interface 112 may be in a neutral logic state (common mode voltage). In a “Slumber” state, the processor 110 and the interface 112 may be powered on, but in a reduced power state. That is, the Partial and Slumber modes may reduce the power consumption of the interface 112.

The controller 111 may control an initiate power management (IPM) function. That is, the controller 111 may control the entry of the processor 110 and/or the interface 112 into the Partial or the Slumber mode to reduce the power consumption of, for example, the interface 112 and/or the processor 110.

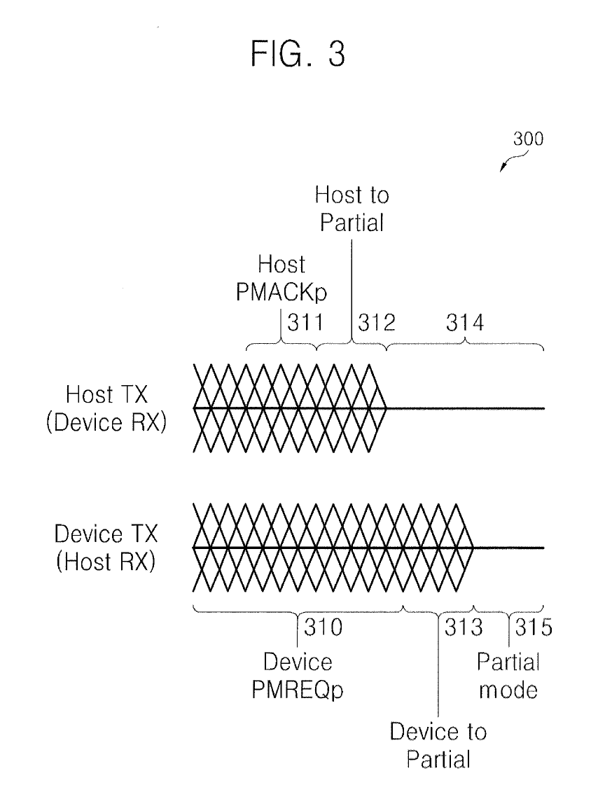

Referring to FIG. 3, the IPM function as controlled by the controller 111 will be described in connection with the timing diagram 300. FIG. 3 illustrates a Device Initiate Power Management (DIPM) function of the IPM, where the device is the digital processing device 100 which enters the Partial mode. The interface 112 outputs the signal PMREQp to the host 200 in order to signal that the digital processing device is to enter the partial mode in section 310. In response to the PMREQp, the host system 200 may output the acknowledgement signal PMACKp to the HDD 10 or digital storage device 20 as illustrated in section 311 of FIG. 3.

The host system 200 may enter the partial mode after outputting the signal PMACKp to the digital processing device 100 (illustrated in sections 312 and 314 of FIG. 3). The digital processing device 100 may be ready to enter the partial mode after receiving the signal PMACKp from the host system 200 in section 313, and may enter the partial mode in section 315.

In exemplary embodiments of the present general inventive concept, the power management mode of the digital processing device 100 may be selectable by setting the power management mode as enabled or disabled, and storing the set power management mode in the non-volatile memory 113, which may be, for example, a flash memory device or the like. If the power management mode is set and stored as enabled, the controller 111 controls the digital processing device 100 to reduce the power consumption of, e.g., the processor 110 and/or the interface 112 to provide additional power to the HDD 10 or digital memory device 12 to achieve a normal operation ready state, as discussed in detail below. If the power management mode is set and stored as disabled, the controller 111 controls the digital processing device 100 so as to not reduce the power consumption of, e.g., the processor 110 and/or the interface 112.

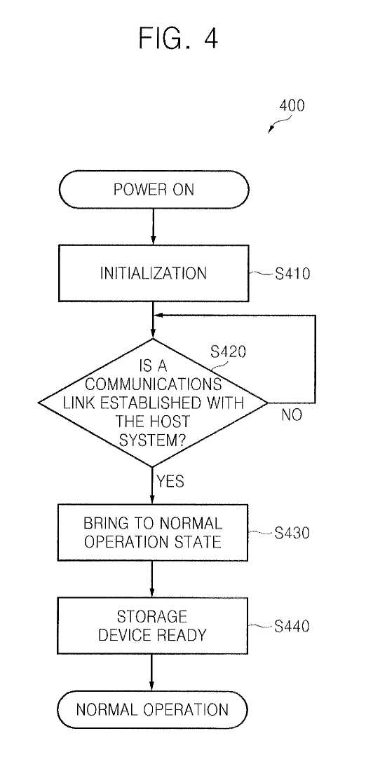

FIG. 4 illustrates a method of staggering spin-up of the HDD 10 and/or staggering the reaching of a normal operating mode by the digital storage device 12 in operations 400, and is described below. Power may be provided to the HDD 10 and/or digital storage device 20 by a power source of the digital processing device 100, and the HDD 10 and/or digital storage device 20 may be initialized at operation S410. The initialization may include, for example, reaching an operating state so as to synchronize communications between HDD 10 and/or digital storage device 20 and the processor 110.

The controller 111 and/or the processor 110 may determine whether a wired and/or wireless communications link is established between the host system 200 and the digital processing device at operation S420. If a communications link is determined to be established, the controller 111 controls the spin-up HDD 10 to a predetermined normal operating speed, or the controller 111 controls the bringing the digital storage device 20 to a normal operation ready state at operation S430. If a communications link is not determined to be established between the host system 200 and the digital processing device at operation S420, the controller 111 and/or the processor 110 may again determine whether a wired and/or wireless communications link is established between the host system 200 and the digital processing device at operation S420 after a predetermined period of time has elapsed since the previous determination.

The HDD 10 and/or the digital processing device 20 may provide a signal to the controller 111 and/or the processor 110 indicating that the HDD 10 and/or digital storage device has operational ready status at operation S440, and that the HDD 10 and/or the digital storage device 20 is operating at a normal operation state.

In exemplary embodiments of the present general inventive concept, the power consumption to the interface 112 or the processor 110 may be reduced before a spin-up operation of the HDD 10 or before the digital storage device 20 achieves a normal operation ready state. By staggering the spin-up of the disks 11 of the HDD 10, or by staggering the bringing the digital storage device 20 to the normal operation ready state, the power consumption of the interface 112 or the processor 110 may be reduced for example, after a wired or wireless communications link is established between the host system 200 and the digital processing device 100.

The HDD 10 and/or the digital memory device 20 of the present general inventive concept may use an Initiate Power Management (IPM) operation to reduce the power consumption of the interface 112 and/or the processor 110. The IPM may be a Device Initiated Power Management (DIPM) operation (e.g., where the digital processing device 100 initiates the power management by communicating the power management mode to the host system 200), or the IPM may be a Host Initiated Power Management (HIPM) operation (e.g., where the host system 200 requests the power management of the HDD 10 or digital processing device 20).

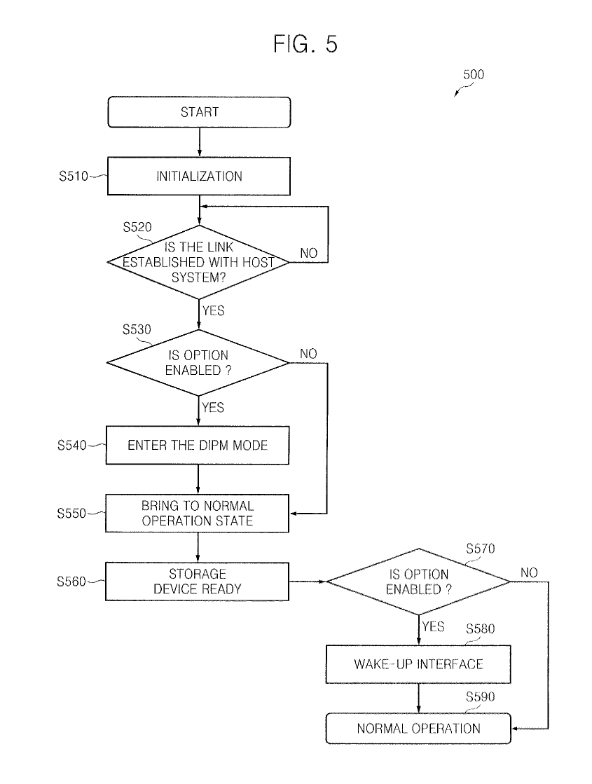

FIG. 5 illustrates the operations 500 of staggering the spin-up of disks 11 of the HDD 10 and/or bringing the digital storage device 20 to a normal operation mode with a DIPM operation of the IPM.

The HDD 10 and/or the digital storage device 20 may me initialized at operation S510. For example, the initialization operation may be the same as described above in connection with operation S410 illustrated in FIG. 4.

The controller 111 and/or processor 100 may determine whether a wired or wireless communications link is established between the host system 200 and the digital processing device 100 at operation 520.

If it is determined that the communications link is established, the controller 111 and/or the processor 110 may determine whether the power management function information that is stored in the memory 113 is enabled or disabled at S530. Alternatively, the power management function information may be stored in the HDD 10 and/or the digital memory device 20.

If it is determined that the power management function is enabled, the controller 111 may control the interface 112 and/or the processor 110 to enter a power consumption reduction mode such as the Partial or Slumber mode discussed above using IPM (e.g., using DIPM) at operation S540. That is, the power consumption of the interface 112 and/or to the processor 110 may be reduced so as to provide power to the HDD 10 to spin-up the disks 11 to a predetermined operating speed and/or provide power to the digital storage device 20 to bring the digital storage device 20 to a normal operation ready state. The disks 11 of the HDD 10 may be at the predetermined operating speed and/or the digital storage device 20 may be at the normal operation ready state at operation S560.

If it is determined from the stored information that the power management function is disabled, the controller 111 may control the spin-up of disks 11 of the HDD 10 and/or the bringing of the digital storage device 20 to the normal operation state without controlling the power reduction consumption of the interface 112 and or the processor 110 at operation S550. That is, the disks 11 of the HDD 10 may be at the predetermined operating speed and/or the digital storage device 20 may be at the normal operation ready state at operation S560 without, for example, reducing the power consumption of the interface 112 and/or the processor 110.

The controller 111 and/or the processor 110 may determine whether the power management function information that is stored in the memory 113 is enabled or disabled at operation S570. That is, the controller 111 and/or the processor 110 may determine whether the information stored in the memory 113 indicates that the power management function is enabled or disabled.

If the determined information at operation S570 indicates that the power management function is disabled, the disks 11 of the HDD 10 may spin-up to the predetermined operation speed and/or a normal operation ready state may be achieved by the digital storage device 20 without changing the power consumption of the interface 112 and/or the processor 110. That is, the HDD10 and/or the digital storage device 20 may be at a normal operation state at operation S590.

If the determined information at operation S570 indicates that the power management function is enabled, the controller 111 may “wake up” the interface 112 at operation S580, and the disks 11 of the HDD 10 may spin-up to the predetermined operation speed and/or a normal operation ready state may be achieved by the digital storage device 20 at operation S590. That is, the wake up of the interface 112 may include setting the power status of the interface 112 from either the “Partial” or “Slumber” modes to the “PHYRDY” mode, as described above.

Alternatively, the controller 111 and/or the processor 110 may determine whether the information indicates that the power management function is enabled or disabled and may check a memory register (not illustrated) in the processor 110 and/or the digital processing device 100 at operation S570, where the register may store the power consumption status information of the interface 112. If the information indicates the interface 112 is in a power consumption reduction mode, the controller 111 and/or the processor 110 may then wake up the interface 112 at operation S580 by changing the power status of the interface from “Partial” or “Slumber” to, for example, “PHYRDY.”

In exemplary embodiments of the present general inventive concept, the digital processing device 100 may set the power management function to enable or disable. The controller 111 may change the information indicating that the power management function is enabled or disabled. For example, the controller 111 may change the stored information to indicate that the power management function is enabled or disabled according to a request received from the host system 200.

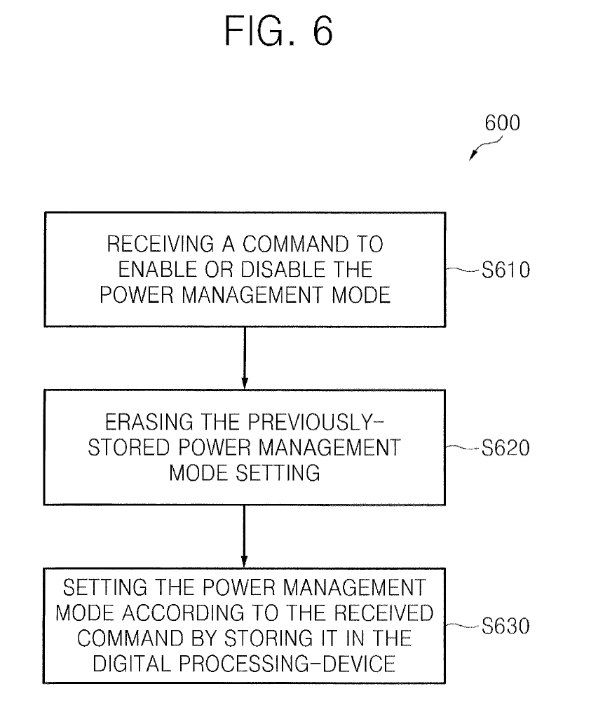

FIG. 6 illustrates a method 600 of setting the information of the power management mode to enable or disable the power management mode. A request and/or command may be received by the digital processing device 100 via the interface 112 from the host system 200 to enable or disable the power management mode, or the controller 111 and/or the processor 110 may receive a request to enable or disable the power management mode at operation S610.

The controller 111 may store the enable or disable information setting of the power management mode in the memory 113 at operation S620 according to the received request. For example, the value received in the request may be “01,” which may indicate that the power management mode is to be set to enable, or value received may be “00,” which may indicate that the power management mode is to be set to disable.

The controller 111 may erase the power management mode information stored in the memory 113 at operation S620 before update the information setting according to the received information at operation S610. The controller 111 may set the power management mode according to the received request by storing it in the memory 113 of the digital processing device 100.

Although several embodiments of the present general inventive concept have been shown and described, the present invention is not limited to the described embodiments. Instead, it would be appreciated by those skilled in the art that changes may be made to these embodiments without departing from the principles and spirit of the general inventive concept, the scope of which is defined by the claims and their equivalents.

What is claimed is:

1. A method of controlling power consumption of a digital processing device, the method comprising:
determining whether a power management mode of the digital processing device is enabled;
when a power management mode is enabled, reducing power to at least one portion of the digital processing device to fully power one or more memory devices of the digital processing device to a normal operation ready state; and
when the power management mode is disabled, powering the one or more memory devices of the digital processing device to the normal operation ready state.

2. The method of claim 1, further comprising:
when the one or more memory devices of the digital processing device are at the normal operation ready state, determining whether the power management mode of the digital processing device is enabled; and
supplying power to a wired or wireless communications interface of the digital processing device.

3. The method of claim 1, wherein the reducing power to at least one portion of the digital processing device comprises reducing the power to a wired or wireless communications interface of the digital processing device.

4. The method of claim 1, further comprising:
determining that a communications link has been established between the digital processing device and a host device before the determining whether the power management mode of the digital processing device is enabled.

5. The method of claim 1, wherein the determining whether a power management mode of the digital processing device is enabled comprises:
receiving a request from a host via a wired or wireless communications link to enable or disable the power management mode; and
setting the power management mode according to the received command by storing the set mode in a memory device of the digital processing device.

6. The method of claim 5, further comprising:
erasing any previously-stored power management mode setting.

7. The method of claim 1, further comprising:
transmitting a request to enable the power management mode from the digital processing device to a host device;
transmitting an acknowledgement of the request from the host device to the digital processing device; and
operating the host device and the digital processing device in the power management mode.

8. The method of claim 7, wherein the operating the host device in the power management mode comprises:
withholding requests to read data from or write data to the digital processing device until the digital processing device is in the normal operation ready state.

9. The method of claim 1, wherein the digital processing device includes a hard disk drive and the normal operation ready state is a predetermined operation speed of the hard disk drive.

10. The method of claim 1, wherein the digital processing device includes one or more solid state memory devices and when the power management mode is enabled, transferring power applied to charge capacitors to power the one or more solid state memory devices to the normal operation ready state.

11. A controller to control a digital processing device, the controller comprising:
a power management mode determination device to determine whether a power management mode of the digital processing device is enabled; and
a power controller to reduce power to at least one portion of the digital processing device to fully power one or more memory devices of the digital processing device to a normal operation ready state, and to power the one or more memory devices of the digital processing device to the normal operation ready state when the power management mode is disabled.

12. The controller of claim 11, further comprising:
a processor to determine whether the power management mode of the digital processing device is enabled when the one or more memory devices of the digital processing device are at the normal operation ready state; and
the power controller to supply power to a wired or wireless communications interface of the digital processing device.

13. The controller of claim 11, wherein the power reduces the power to a wired or wireless communications interface of the digital processing device.

14. The controller of claim 11, wherein the power management mode determination device determines that a communications link has been established between the digital processing device and a host device before the determining whether the power management mode of the digital processing device is enabled.

15. The controller of claim 11, further comprising:
a wired or wireless communications interface to receive a request from a host to enable or disable the power management mode; and
a digital storage device to set and store the power management mode.

16. The controller of claim 15, wherein the digital storage device erases any previously-stored power management mode setting in the digital storage device.

17. The controller of claim 11, further comprising:
a wired or wireless communications interface to transmit a request to enable the power management mode from the digital processing device to a host device, and to receive an acknowledgement of the request from the host device to the digital processing device,
wherein the controller operates the host device and the digital processing device in the power management mode upon receipt of the acknowledgement.

18. The controller of claim 17, wherein the controller withholds requests from the host to read data from or write data to the digital processing device until the digital processing device is in the normal operation ready state.

19. The controller of claim 11, further comprising:
a hard disk drive communicatively coupled to the controller,
wherein the normal operation ready state is a predetermined operation speed of the hard disk drive.

20. The controller of claim 11, wherein the power controller transfers power applied to charge capacitors of the digital processing device that includes one or more solid state memory devices to power the one or more solid state memory devices to the normal operation ready state when the power management mode is enabled.
